(19) United States
(12) Patent Application Publication
(10) Pub. No.: US 2025/0016703 A1
(43) Pub. Date: Jan. 9, 2025

(54) COMMUNICATION METHOD, TERMINAL, AND NETWORK DEVICE

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN); Xinlei YU, Dongguan (CN)

(21) Appl. No.: 18/892,114

(22) Filed: Sep. 20, 2024

Related U.S. Application Data
(63) Continuation of application No. PCT/CN2022/088741, filed on Apr. 24, 2022.

(51) Int. Cl. H04W 56/00

(52) U.S. Cl. CPC H04W 56/004; H04W 56/0065

(57) ABSTRACT

Provided are a communication method, a terminal, and a network device. The communication method includes: sending, by a terminal, first indication information to a first network device in response to satisfaction of a first event, where first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

### CROSS-REFERENCE TO RELATED APPLICATIONS

This application is a continuation of International Application No. PCT/CN2022/088741, filed on Apr. 24, 2022, the disclosure of which is hereby incorporated by reference in its entirety.

### TECHNICAL FIELD

This application relates to the field of communications technologies, and more specifically, to a communication method, a terminal, and a network device.

### BACKGROUND

In some communications systems, a signal propagation delay difference (that is, a delay difference) between network devices to which different cells belong may be compensated for through configuring measurement information, so as to enable measurement. A signal transmission delay difference between the network devices to which the different cells belong may be relatively large, which may result in the configuration of the measurement information leading to relatively large energy consumption or affecting user experience.

### SUMMARY

This application provides a communication method, a terminal, and a network device.

According to a first aspect, a communication method is provided, including: sending, by a terminal, first indication information to a first network device in response to satisfaction of a first event, where the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

According to a second aspect, a communication method is provided, including: receiving, by a first network device in response to satisfaction of a first event, first indication information sent by a terminal, where the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

According to a third aspect, a terminal is provided, including: a first sending unit, configured to send first indication information to a first network device in response to satisfaction of a first event, where the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

According to a fourth aspect, a network device is provided, including: a second receiving unit, configured to receive, in response to satisfaction of a first event, first indication information sent by a terminal, where the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

According to a fifth aspect, a terminal is provided, including a processor, a memory, and a communications interface. The memory is configured to store one or more computer programs. The processor is configured to invoke the computer programs in the memory to cause the terminal to perform the method in the first aspect.

According to a sixth aspect, a network device is provided, including a processor, a memory, and a communications interface. The memory is configured to store one or more computer programs. The processor is configured to invoke the computer programs in the memory to cause the network device to perform the method in the second aspect.

According to a seventh aspect, an embodiment of this application provides a communications system. The system includes the foregoing terminal and/or network device. In another possible design, the system may further include another device interacting with the terminal or the network device in the solutions provided in embodiments of this application.

According to an eighth aspect, an embodiment of this application provides a computer-readable storage medium. The computer-readable storage medium stores a computer program. The computer program causes a terminal to perform some or all of the steps in the method in the first aspect.

According to a ninth aspect, an embodiment of this application provides a computer-readable storage medium. The computer-readable storage medium stores a computer program. The computer program causes a network device to perform some or all of the steps in the method in the second aspect.

According to a tenth aspect, an embodiment of this application provides a computer program product. The computer program product includes a non-transitory computer-readable storage medium that stores a computer program. The computer program is operable to cause a terminal to perform some or all of the steps in the method in the first aspect. In some implementations, the computer program product may be a software installation package.

According to an eleventh aspect, an embodiment of this application provides a computer program product. The computer program product includes a non-transitory computer-readable storage medium that stores a computer program. The computer program is operable to cause a network device to perform some or all of the steps in the method in the second aspect. In some implementations, the computer program product may be a software installation package.

According to a twelfth aspect, an embodiment of this application provides a chip. The chip includes a memory and a processor. The processor may invoke and run a computer program from the memory, to implement some or all of the steps described in the method in the first aspect or the second aspect.

According to a thirteenth aspect, a computer program product is provided, and the computer program product includes a program that causes a computer to perform the method in the first aspect.

According to a fourteenth aspect, a computer program product is provided, and the computer program product includes a program that causes a computer to perform the method in the second aspect.

According to a fifteenth aspect, a computer program is provided. The computer program causes a computer to perform the method in the first aspect.

According to a sixteenth aspect, a computer program is provided. The computer program causes a computer to perform the method in the second aspect.

### BRIEF DESCRIPTION OF DRAWINGS

FIG. 1 is a schematic diagram of a wireless communications system to which an embodiment of this application is applied.

FIG. 2 is a schematic diagram of a satellite network architecture.

FIG. 3 is a schematic flowchart of a communication method according to an embodiment of this application.

FIG. 4 is a schematic diagram of a structure of a terminal according to an embodiment of this application.

FIG. 5 is a schematic diagram of a structure of a network device according to an embodiment of this application.

FIG. 6 is a schematic diagram of a structure of an apparatus according to an

embodiment of this application.

### DESCRIPTION OF EMBODIMENTS

The following describes technical solutions of this application with reference to the accompanying drawings.

### Communications System

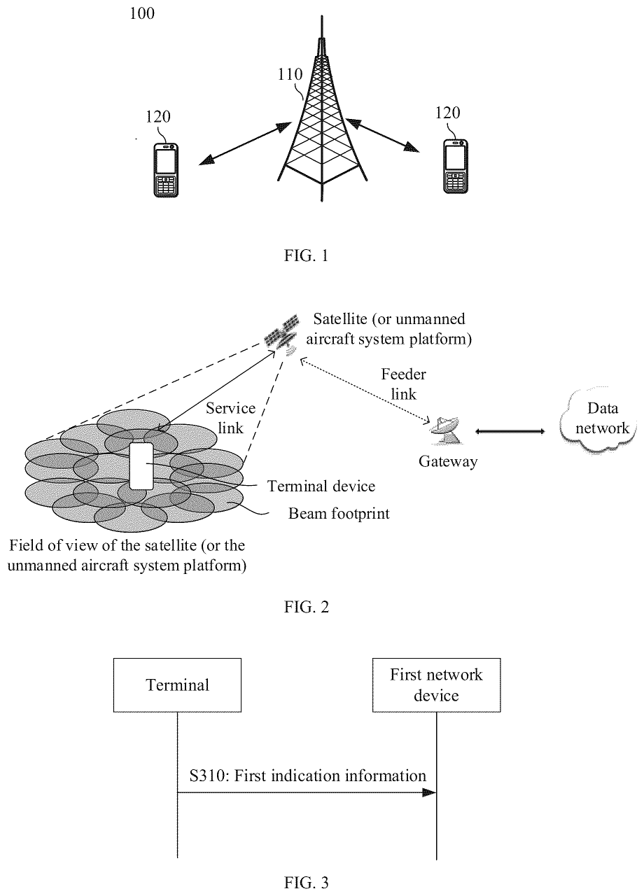

FIG. 1 shows a wireless communications system 100 to which an embodiment of this application is applied. The wireless communications system 100 may include a network device 110 and terminal devices 120. The network device 110 may be a device that communicates with the terminal devices 120. The network device 110 may provide communication coverage for a specific geographic area, and may communicate with the terminal devices 120 located within the coverage area.

FIG. 1 exemplarily shows one network device and two terminals. Optionally, the wireless communications system 100 may include a plurality of network devices, and another quantity of terminal devices may be included in a coverage range of each network device. This is not limited in embodiments of this application.

Optionally, the wireless communications system 100 may further include another network entity such as a network controller or a mobility management entity. This is not limited in embodiments of this application.

It should be understood that the technical solutions of embodiments of this application may be applied to various communications systems, such as a 5th generation (5G) system or new radio (NR), a long term evolution (LTE) system, an LTE frequency division duplex (FDD) system, and LTE time division duplex (TDD). The technical solutions provided in this application may be further applied to a future communications system, such as a 6th generation mobile communications system or a satellite communications system.

The terminal device in embodiments of this application may also be referred to as user equipment (UE), an access terminal, a subscriber unit, a subscriber station, a mobile, a mobile station (MS), a mobile terminal (MT), a remote station, a remote terminal, a mobile device, a user terminal, a terminal, a wireless communications device, a user agent, or a user apparatus. The terminal device in embodiments of this application may refer to a device providing a user with voice and/or data connectivity and may be configured to connect people, objects, and machines, such as a handheld device or vehicle-mounted device having a wireless connection function. The terminal device in embodiments of this application may be a mobile phone, a tablet computer (Pad), a notebook computer, a palmtop computer, a mobile Internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, or the like. Optionally, the UE may be used to serve as a base station. For example, the UE may serve as a scheduling entity, which provides a sidelink signal between UEs in V2X, D2D, or the like. For example, a cellular phone and a vehicle communicate with each other by using a sidelink signal. A cellular phone and a smart home device communicate with each other, without the relay of a communication signal through a base station.

The network device in embodiments of this application may be a device for communicating with the terminal device. The network device may also be referred to as an access network device or a radio access network device. For example, the network device may be a base station. The network device in embodiments of this application may refer to a radio access network (RAN) node (or device) that connects the terminal device to a wireless network. The base station may broadly cover various names below, or may be replaced with the following names, such as a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. The base station may alternatively refer to a communications module, a modem, or a chip that is used to be disposed in the foregoing device or apparatus. Alternatively, the base station may be a mobile switching center, a device that functions as a base station in device to device D2D, vehicle-to-everything (V2X), and machine-to-machine (M2M) communication, a network-side device in a 6G network, a device that functions as a base station in a future communications system, or the like. The base station may support networks of the same or different access technologies. A specific technology and a specific device form used by the network device are not limited in embodiments of this application.

The base station may be fixed or mobile. For example, a helicopter or an unmanned aerial vehicle may be configured to serve as a mobile base station, and one or more cells may move depending on a location of the mobile base station. In another example, a helicopter or an unmanned aerial vehicle may be configured to serve as a device in communication with another base station.

In some deployments, the network device in embodiments of this application may refer to a CU or a DU, or the network device includes a CU and a DU. The gNB may further include an AAU.

It should be understood that all or some of functions of the communications device in this application may also be implemented by software functions running on hardware, or by virtualization functions instantiated on a platform (for example, a cloud platform).

The network device and the terminal device may be deployed on land, including being indoors or outdoors, handheld, or vehicle-mounted; may be deployed on a water surface; or may be deployed on a plane, a balloon, or a satellite in the air. In embodiments of this application, a scenario in which the network device and the terminal device are located is not limited.

### Non-Terrestrial Network (NTN)

The NTN provides communication services to users in a non-terrestrial manner. The non-terrestrial manner may include, for example, a satellite or an unmanned aircraft system platform (UAS platform).

For terrestrial network communication, in a scenario such as a sea, a mountain, or a desert, a communications device cannot be set up for land communication. Alternatively, considering construction and operation costs of the communications device, land communication generally does not cover a sparsely populated area. The NTN has many advantages over terrestrial network communication. First, NTN communication may not be limited by a user area. The NTN communications network is not limited by an area. In theory, a satellite may orbit the earth, so that every corner of the earth can be covered by satellite communication. In addition, an area that may be covered by an NTN communications device is far larger than an area covered by a terrestrial communications device. For example, in satellite communication, a satellite may cover a relatively large terrestrial area. Second, NTN communication has a great social value. NTN communication may implement coverage at low costs, for example, may cover remote mountains or poor and backward countries or regions at low costs by using satellite communication. This enables people in these regions to enjoy advanced voice communication and mobile Internet technologies, which helps narrow a digital divide with developed regions and promote development of these regions. Third, a communication distance of NTN communication is long, and communication costs are not significantly increased. In addition, NTN communication has high stability. For example, NTN communication may not be limited by a natural condition, and may be used even in a case of a natural disaster.

### Communications Satellite

According to different orbital altitudes, communications satellites may be classified into a low-earth orbit (LEO) satellite, a medium-earth orbit (MEO) satellite, a geostationary earth orbit (GEO) satellite, a high elliptical orbit (HEO) satellite, and the like. The following describes the LEO satellite and the GEO satellite in detail.

An orbit height of the LEO satellite ranges from 500 km to 1500 km. An orbital period is about 1.5 hours to 2 hours. A signal propagation delay of single-hop communication between users is generally less than 20 ms. A maximum satellite visible time is 20 minutes. A signal propagation distance is short, a link loss is small, and a transmit power requirement for a user terminal is not high.

An orbit height of the GEO satellite is 35786 km. A rotation period of the GEO satellite around the earth is 24 hours. A signal propagation delay of single-hop communication between users is generally 250 ms.

To ensure satellite coverage and improve a system capacity of the entire satellite communications system, the satellite may use a plurality of beams to cover the ground, that is, a plurality of beam footprints (beam foot print) may form a field of view of the satellite. For example, one satellite may form dozens or even hundreds of beams to cover the ground. One satellite beam may cover a terrestrial area of tens to hundreds of kilometers in diameter.

### Satellite Network Architecture

An NTN network may be implemented based on a satellite network architecture. The satellite network architecture may include the following network elements: a gateway, a feeder link, a service link, a satellite, an inter-satellite link, and the like.

There may be one or more gateways. The gateway may be configured to connect a satellite to a terrestrial public network. The gateway is usually located on the ground.

The feeder link may be a link for communication between the gateway and the satellite.

The service link may be a link for communication between a terminal device and the satellite.

The satellite may be classified into a transparent payload satellite and a regenerative payload satellite in terms of functions provided by the satellite.

FIG. 2 is a schematic diagram of a network architecture based on a transparent payload satellite. The transparent payload satellite may provide functions of radio frequency filtering, frequency conversion, and amplification. The transparent payload satellite only provides transparent forwarding of signals, and does not change waveform signals forwarded by the satellite.

### Measurement

Measurement may refer to mobility measurement in a connected state. After a network device delivers a measurement configuration to a terminal, the terminal may detect a signal quality status of a neighboring cell based on parameters such as a measurement object and a reporting configuration that are indicated in the measurement configuration, and feed back measurement reporting information to a network, so that the network performs switching or improves a neighboring cell relationship list.

### Measurement Configuration

In some communications systems (for example, an NR system), a network device may send measurement configuration information to a terminal in a connected state by using radio resource control (RRC) signalling. The terminal may perform measurement based on content of the measurement configuration information. The measurement may include one or more of the following types of measurement: intra-frequency measurement, inter-frequency measurement, or inter-technology measurement. The terminal may report a measurement result to the network device. The network device may perform measurement configuration by using RRC connection reconfiguration signalling. The measurement configuration information may include one or more of the following content: a measurement object, a reporting configuration, a measurement identity, or a measurement gap.

For different measurement, content indicated by the measurement object may be different.

For intra-frequency measurement and inter-frequency measurement, the measurement object may indicate a time-frequency location where the measurement is to be performed and a subcarrier spacing of a reference signal. For a cell related to the measurement object, the network device may configure one or more of a cell offset list, a cell blacklist, or a cell whitelist.

For inter-technology measurement, the measurement object may correspond to a single inter-technology frequency. The inter-technology frequency may be, for example, an evolved UTRAN (E-UTRA) frequency. For a cell related to the inter-technology frequency, the network device may configure one or more of a cell offset list, a cell blacklist, or a cell whitelist.

For a blacklisted cell, the terminal may perform no operation in event evaluation and measurement reporting. For a whitelisted cell, the terminal may perform event evaluation and measurement reporting.

For a measurement frequency, the network device may configure a synchronization signal block measurement timing configuration (SS/PBCH block measurement timing configuration, SMTC). The SMTC may be used to indicate a time of receiving a synchronization signal block (SSB) on a neighboring cell corresponding to the frequency by the terminal. The SMTC information may include one or more of the following information: a period of the SMTC, a start time offset of the SMTC in one period, duration of the SMTC, or the like.

One measurement object may correspond to one or more reporting configurations. The reporting configuration may include one or more of the following information: a reporting criterion, a reference signal (RS) type, or a reporting format.

The reporting criterion may be a trigger condition for performing measurement reporting by the terminal. The trigger condition may be, for example, periodically triggered reporting or event-triggered reporting.

The RS type may be used to indicate an RS used by the terminal for beam and cell measurement. The RS may be, for example, an SS/PBCH block or a channel state information-reference signal (CSI-RS).

The reporting format may be a measurement reporting quantity of the terminal for a cell and/or a beam. The measurement reporting quantity may be, for example, reference signal received power (RSRP). The reporting format for a measurement further includes other related information. The other related information may include, for example, a maximum quantity of cells that is reported by the terminal and/or a maximum quantity of beams that is reported for a cell.

The measurement identity may be a single identity (ID) for associating the measurement object with the reporting configuration. One measurement object may be associated with one or more reporting configurations, or one reporting configuration may be associated with one or more measurement objects. The foregoing association may be distinguished by using the measurement identity.

The measurement gap may be used to indicate a time of performing inter-frequency/inter-system measurement by the terminal. The terminal may perform inter-frequency/inter-system measurement during the measurement gap. A measurement gap configuration may include one or more of the following information: a period of the measurement gap, a start time offset of the measurement gap in one period, duration of the measurement gap, or the like.

### Measurement Reporting

A terminal may perform measurement based on a measurement configuration delivered by a network device. When a specific trigger condition is satisfied, the terminal may perform evaluation on measurement reporting. If a reporting condition is satisfied, the terminal may fill in a measurement report and send the measurement report including a measurement result to a network.

Types of measurement reporting include event-triggered reporting, periodic reporting, and event-triggered periodic reporting.

For event-triggered reporting, the terminal may trigger sending of the measurement report only after a measurement event entry threshold configured by the network is continuously satisfied over a period of time. A procedure ends after the measurement report is sent once.

Measurement events supported in some communications systems (for example, an NR system) may include some or all of the following events: an A1 event, an A2 event, an A3 event, an A4 event, an A5 event, an A6 event, a B1 event, and a B2 event.

The A1 event may include that signal quality of a serving cell is higher than a threshold. The A2 event may include that signal quality of a serving cell is lower than a threshold. The A3 event may include that signal quality of a neighboring cell is higher than signal quality of a special cell (SpCell) by a threshold. The A4 event may include that signal quality of a neighboring cell is higher than a threshold. The A5 event may include that signal quality of SpCell is lower than a threshold 1, and signal quality of a neighboring cell is higher than a threshold 2. The A6 event may include that signal quality of a neighboring cell is higher than signal quality of a secondary cell (SCell) by a threshold. The B1 event may include that signal quality of an inter-technology neighboring cell is higher than a threshold. The B2 event may include that signal quality of a primary cell (PCell) is lower than a threshold 1, and signal quality of an inter-technology neighboring cell is higher than a threshold 2.

A reporting configuration corresponding to an event-triggered reporting criterion may include that a trigger type is an “event”. The event may include a measurement event among A1 to A6 and B1 and B2 and a threshold parameter thereof. Alternatively, a quantity of reporting times in a reporting configuration corresponding to an event-triggered reporting criterion is 1. The terminal may ignore a reporting gap in the reporting configuration. It may be understood that, regardless of a value of the reporting gap, the reporting gap may be ignored by the terminal.

For periodic reporting, after the network device configures measurement, the terminal may perform measurements on a corresponding frequency based on configuration content. The terminal may also send a measurement report based on a specified reporting period and gap.

A reporting configuration corresponding to a periodic reporting criterion may include that a trigger period is a “period”. The “period” may include, for example, “reportCGI” and “reportStrongestCell”. If the reporting serves the purpose of “reportCGI”, a quantity of reporting times may be equal to 1. If the reporting serves the purpose of “reportStrongestCell”, the quantity of reporting times may be greater than 1. If the terminal is configured with reporting for the purpose of “reportCGI”, a T321 timer may be enabled. If content required for reporting is obtained before the T321 timer expires, the terminal may stop T321 and initiate the reporting in advance, so that the network can obtain information required for establishing a neighboring cell list as soon as possible.

For event-triggered periodic reporting, the terminal may trigger sending of the measurement report after a measurement event entry threshold configured by the network is satisfied and this case lasts for a period of time. After the reporting is triggered, a timer between a plurality of measurements and a counter of a quantity of measurements may be enabled, and the procedure ends until the quantity of reporting times meets a requirement. A reporting configuration corresponding to an event-triggered periodic reporting criterion may include that a trigger type is an “event”. The “event” may include a measurement event among A1 to A5 and a threshold parameter thereof. The quantity of reporting times may be greater than 1. The reporting gap is valid. The network device may set a reporting period timer based on a configured gap parameter.

There is a delay in signal propagation between the terminal and a network device of a cell. Distances between the terminal and network devices of different cells may be different. Therefore, propagation delays between the terminal and the network devices of different cells may also be different. In other words, there is a delay difference.

In some cases, a propagation delay difference between the network devices of different cells is relatively small. For example, for some terrestrial cellular communications cells, coverage radii of the cells are relatively small, and a signal propagation delay difference between the network devices of different cells is relatively small. In these cases, duration of an SMTC may be configured to compensate for the signal propagation delay difference between the network devices of different cells, so that the terminal can receive SSBs of different cells within the duration of the SMTC. Alternatively, duration of a measurement gap may be configured, so that the measurement performed by the terminal on an inter-frequency/inter-technology frequency that needs to be measured is conducted during the measurement gap. In some communication standards, a maximum configurable value of the duration of the SMTC is 5 ms, and a maximum configurable value of the duration of the measurement gap is 6 ms. In some communication standards, the measurement gap is configured based on a terminal, and the SMTC is configured based on a frequency.

In some other cases, a signal propagation delay between the terminal and the network device of the cell increases. As a result, a signal propagation delay difference between base stations of different cells is relatively large. For example, because a field of view of a satellite is very large, a signal propagation delay between a terminal and the satellite in an NTN greatly increases. As a result, a relatively large signal propagation delay difference between the terminal and different satellites exists. In other words, a propagation delay difference is relatively large.

The transparent payload satellite shown in FIG. 2 is used as an example. A base station of a cell may be located on the ground, and the satellite may provide transparent forwarding. An SSB signal sent by the terrestrial base station can reach the satellite through a feeder link, and then reach a terminal through a service link. It may be understood that the delay in either the feeder link or the service link may differ for different satellites, which causes a relatively large propagation delay difference between the terminal and different satellites.

In a case that the propagation delay difference is relatively large, in order that the terminal can receive SSBs from the network devices of different cells in an SMTC window, the duration of the SMTC may be prolonged, that is, the SMTC window may be prolonged, to compensate for a relatively large delay difference between the terminal and the network devices of different cells. Alternatively, the duration of the measurement gap used by the terminal to perform inter-frequency/inter-technology measurement may be prolonged, that is, a measurement gap window may be prolonged. It may be understood that the prolonging of the SMTC window means that the terminal needs to continuously attempt to receive an SSB in a relatively long SMTC window. This may increase energy consumption of the terminal. The prolonging of the measurement gap window means that the terminal needs to reduce a communication time with a serving cell. This may affect user experience.

FIG. 3 is a schematic flowchart of a communication method according to an embodiment of this application. The method shown in FIG. 3 may be performed by a terminal and a first network device. The method shown in FIG. 3 may include step S310.

Step S310: The terminal sends first indication information to the first network device in response to satisfaction of a first event.

The first indication information is used to indicate a delay difference. The delay difference may be a difference (that is, a difference value) between a first propagation delay and a second propagation delay. The first propagation delay is a propagation delay between the terminal and a second network device to which a first cell belongs. The second propagation delay is a propagation delay between the terminal and a third network device to which a second cell belongs.

A type of the first cell or a type of the second cell or both are not limited in this application. The first cell or the second cell or both may be NTN cells. For example, the first cell may be an NTN cell, and the second cell may also be an NTN cell. Alternatively, the first cell is an NTN cell, and the second cell is a terrestrial cellular communications cell. Alternatively, the first cell is a terrestrial cellular communications cell, and the second cell is an NTN cell.

It may be understood that, when the first cell is an NTN cell, the second network device to which the first cell belongs may be a satellite. The first propagation delay between the terminal and the second network device may be a delay in a service link. When the second cell is an NTN cell, the third network device to which the second cell belongs may be a satellite. The second propagation delay between the terminal and the third network device may be a delay in a service link. When both the first cell and the second cell are NTN cells, the delay difference may be a delay difference in a service link.

Optionally, the first cell may be a serving cell or a neighboring cell, and the second cell may be a serving cell or a neighboring cell. For example, the first cell may be a serving cell, and the second cell may be a neighboring cell. Alternatively, the first cell may be a neighboring cell, and the second cell may be a serving cell.

The propagation delay may be a unidirectional propagation delay or a bidirectional propagation delay. Correspondingly, the delay difference may be a unidirectional delay difference or a bidirectional delay difference.

It may be understood that the unidirectional delay may be obtained through calculation based on the light speed and a distance between the terminal and the network device. For example, the unidirectional delay may be obtained by dividing the distance between the terminal and the network device by the light speed. The first propagation delay may be obtained by dividing a distance between the terminal and the second network device by the light speed. The second propagation delay may be obtained by dividing a distance between the terminal and the third network device by the light speed. The unidirectional delay difference may be obtained based on the unidirectional delay.

It may be understood that the bidirectional delay difference may be, for example, twice the unidirectional delay difference. The bidirectional delay difference may be calculated based on the bidirectional delay.

In an implementation, the propagation delay may be determined based on a positioning capability of the terminal. The positioning capability may include, for example, a global navigation satellite system (GNSS) capability. For example, the terminal may determine location information of the terminal based on the positioning capability. The distance between the terminal and the network device may be determined based on the location information of the terminal and location information of the network device, so that the propagation delay can be determined based on the distance between the terminal and the network device. When the second or third network device is a satellite, location information of the satellite may be obtained based on ephemeris information.

The propagation delay difference may be used to assist the network device in adjusting measurement configuration information, to reduce energy consumption or improve user experience. For example, the first network device may determine or adjust the measurement configuration information based on the first indication information reported by the terminal. The measurement configuration information may include, for example, SMTC information and/or measurement gap configuration information.

In an implementation, both the first cell and the second cell may be NTN cells, the first cell is a serving cell, and the second cell is a neighboring cell. The first network device may configure, for the terminal, an SMTC offset related to the satellite of the second cell based on a service link delay difference that is reported by the terminal and related to the satellite to which the first cell belongs and the satellite of the second cell, and with reference to a feeder link delay difference of the satellite of the second cell and the satellite of the first cell on a network device side.

In another implementation, the first cell may be a serving cell, the second cell may be a neighboring cell, and the second network device of the first cell may determine, based on the propagation delay difference, a time at which the terminal generally needs to perform measurement on the neighboring cell, to configure an appropriate measurement gap.

The first event may be related to a first difference and the second difference. The first difference may be a current delay difference, and the second difference may be a last reported delay difference. For example, both the first cell and the second cell are NTN cells. The first difference may be a current service link delay difference, and the second difference may be a last reported service link delay difference.

In an embodiment, the first event may include that a difference value between the first difference and the second difference is greater than or equal to a first threshold. In other words, the first event may include: First difference−Second difference≥First threshold. A value of the first threshold may be greater than or equal to 0. It may be understood that the first event may be satisfied in a case that the current delay difference has increased compared to the last reported delay difference, and the magnitude of the increase is greater than the first threshold.

In another embodiment, the first event may include that a difference value between the first difference and the second difference is less than or equal to a second threshold. In other words, the first event may include: First difference−Second difference≤Second threshold. A value of the second threshold may be less than or equal to 0. It may be understood that the first event may be satisfied in a case that the current delay difference has decreased compared to the last reported delay difference, and the magnitude of the decrease is greater than an absolute value of the second threshold.

In still another embodiment, the first event may include that a variation value between the first difference and the second difference is greater than or equal to a third threshold. In other words, the first event may include: abs (First difference−Second difference)≥Third threshold. Herein, abs represents obtaining an absolute value. A value of the third threshold may be greater than or equal to 0. It may be understood that the first event may be satisfied in a case that the current delay difference has increased or decreased (that is, has changed) compared to the last reported delay difference, and the magnitude of the increase or decrease is greater than the third threshold.

It may be understood that the reporting of the first indication information may be triggered by the first event. In other words, the reporting of the delay difference to the network device by the terminal may be triggered based on the event. Through event-based triggering, signalling for reporting the delay difference may be reduced, thereby reducing occupation of communication resources.

The terminal may evaluate, based on the first event, when to report the first indication information. For example, in a case that the first event is satisfied, the terminal may immediately send the first indication information to the first network device. Alternatively, in a case that the first event remains satisfied for a period of time, the terminal may send the first indication information to the first network device.

The first event may be configured by the first network device, or may be preset. For example, the first event may be configured by using first information. For example, the first information may be transmitted by using RRC signalling. In other words, the first event may be configured by using the RRC signalling.

Optionally, sending of the first configuration information may be triggered by the receiving of the first information. For example, the terminal may trigger the reporting of the first configuration information when receiving the first information. It may be understood that the reporting of the first configuration information for the first time may be implemented through the triggering by the first information.

In a case that the second network device is a satellite, the first network device may send second information to the terminal, to indicate information about the satellite. It may be understood that the second information may include information about one or more (that is, one group of) satellites. The information about the satellite which is reported by using the second information may be information about a neighboring satellite.

Optionally, the information about the satellite may include one or more of the following information: ephemeris information of the satellite, an identity of the satellite, or an identity of ephemeris information of the satellite. The identity may be an ID or an index.

The second information may be transmitted by using RRC signalling. It may be understood that the first information and the second information may be transmitted by using the same RRC signalling, or may be transmitted by using different RRC signalling.

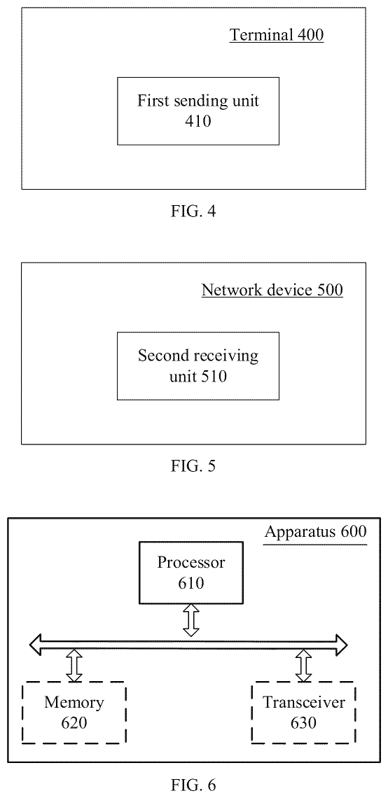

The foregoing describes the method embodiment of this application in detail with reference to FIG. 3. The following describes apparatus embodiments of this application in detail with reference to FIG. 4 to FIG. 6. It should be understood that the descriptions of the method embodiment correspond to descriptions of the apparatus embodiments. Therefore, for parts that are not described in detail, refer to the foregoing method embodiment.

FIG. 4 is a schematic diagram of a structure of a terminal 400 according to an embodiment of this application. The terminal 400 may include a first sending unit 410.

The first sending unit 410 is configured to send first indication information to a first network device in response to satisfaction of a first event, where the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

Optionally, the first cell is a non-terrestrial network NTN cell, and/or the second cell is an NTN cell.

Optionally, the first difference is a current delay difference, and the second difference is a last reported delay difference. The first event includes that a difference value between the first difference and the second difference is greater than or equal to a first threshold; or a difference value between the first difference and the second difference is less than or equal to a second threshold; or a variation value between the first difference and the second difference is greater than or equal to a third threshold.

Optionally, the first event is configured by using first information.

Optionally, the first information is transmitted by using radio resource control RRC signalling.

Optionally, the second network device is a satellite, and the terminal further includes: a first receiving unit, configured to receive second information sent by the first network device. The second information includes information about the satellite.

Optionally, the information about the satellite includes one or more of the following information: ephemeris information of the satellite, an identity of the satellite, or an identity of ephemeris information of the satellite.

Optionally, the second information is transmitted by using RRC signalling.

Optionally, the delay difference is used by the first network device to determine measurement configuration information.

Optionally, the measurement configuration information includes SMTC information and/or measurement gap configuration information.

Optionally, the propagation delay is determined based on a positioning capability of the terminal.

Optionally, the propagation delay is a unidirectional propagation delay or a bidirectional propagation delay.

Optionally, the first cell is a serving cell, and the second cell is a neighboring cell; or the first cell is a neighboring cell, and the second cell is a serving cell.

FIG. 5 is a schematic diagram of a structure of a network device 500 according to an embodiment of this application. The network device 500 may include a second receiving unit 510.

The second receiving unit 510 is configured to receive, in response to satisfaction of a first event, first indication information sent by a terminal, where the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

Optionally, the first cell is a non-terrestrial network NTN cell, and/or the second cell is an NTN cell.

Optionally, the first difference is a current delay difference, and the second difference is a last reported delay difference. The first event includes that a difference value between the first difference and the second difference is greater than or equal to a first threshold; or a difference value between the first difference and the second difference is less than or equal to a second threshold; or a variation value between the first difference and the second difference is greater than or equal to a third threshold.

Optionally, the first event is configured by using first information.

Optionally, the first information is transmitted by using radio resource control RRC signalling.

Optionally, the second network device is a satellite, and the network device further includes: a second sending unit, configured to send second information to the terminal device. The second information includes information about the satellite.

Optionally, the information about the satellite includes one or more of the following information: ephemeris information of the satellite, an identity of the satellite, or an identity of ephemeris information of the satellite.

Optionally, the second information is transmitted by using RRC signalling.

Optionally, the delay difference is used by the first network device to determine measurement configuration information.

Optionally, the measurement configuration information includes SMTC information and/or measurement gap configuration information.

Optionally, the propagation delay is determined based on a positioning capability of the terminal.

Optionally, the propagation delay is a unidirectional propagation delay or a bidirectional propagation delay.

Optionally, the first cell is a serving cell, and the second cell is a neighboring cell; or the first cell is a neighboring cell, and the second cell is a serving cell.

FIG. 6 is a schematic diagram of a structure of a communications apparatus according to an embodiment of this application. The dashed lines in FIG. 6 indicate that the unit or module is optional. The apparatus 600 may be configured to implement the methods described in the foregoing method embodiments. The apparatus 600 may be a chip, a terminal device, or a network device.

The apparatus 600 may include one or more processors 610. The processor 610 may support the apparatus 600 in implementing the methods described in the foregoing method embodiments. The processor 610 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 600 may further include one or more memories 620. The memory 620 stores a program. The program may be executed by the processor 610, so that the processor 610 performs the methods described in the foregoing method embodiments. The memory 620 may be separate from the processor 610 or may be integrated into the processor 610.

The apparatus 600 may further include a transceiver 630. The processor 610 may communicate with another device or chip through the transceiver 630. For example, the processor 610 may send data to and receive data from another device or chip by using the transceiver 630.

An embodiment of this application further provides a computer-readable storage medium for storing a program. The computer-readable storage medium may be applied to the terminal or the network device provided in embodiments of this application, and the program causes a computer to perform the methods performed by the terminal or the network device in various embodiments of this application.

An embodiment of this application further provides a computer program product. The computer program product includes a program. The computer program product may be applied to the terminal or the network device provided in embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the description, claims, and drawings of this application are used for distinguishing different objects from each other, rather than defining a specific order. In addition, the terms “include” and “have” and any variations thereof are intended to cover a non-exclusive inclusion.

The “indication” mentioned in embodiments of this application may be a direct indication or an indirect indication, or indicate an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefining” or “preconfiguring” can be implemented by prestoring corresponding code or a corresponding table in a device (for example, including a terminal device and a network device) or in other manners that can be used for indicating related information. A specific implementation thereof is not limited in this application. For example, predefining may indicate being defined in a protocol.

In embodiments of this application, the “protocol” may indicate a standard protocol in the communication field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution orders. The execution orders of various processes should be determined according to functions and internal logic of the processes, and should not be construed as any limitation on the implementation processes of embodiments of this application.

In the several embodiments provided in this application, it should be understood that the disclosed system, apparatus, and method may be implemented in another manner. For example, the foregoing described apparatus embodiments are merely examples. For example, division into the units is merely logical function division and there may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one location, or may be distributed on a plurality of network units. Some or all of the units may be selected according to actual requirements to achieve the objectives of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on the computer, all or some procedures or functions in embodiments of this application are generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any available medium readable by the computer, or a data storage device, such as a server or a data center, integrating one or more available media. The available medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific embodiments of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
sending, by a terminal, first indication information to a first network device in response to satisfaction of a first event,
wherein the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

2. The communication method according to claim 1, wherein
the first cell is a non-terrestrial network (NTN) cell; and/or
the second cell is an NTN cell.

3. The communication method according to claim 1, wherein a first difference is a current delay difference, a second difference is a last reported delay difference, and the first event comprises that
a difference value between the first difference and the second difference is greater than or equal to a first threshold;
a difference value between the first difference and the second difference is less than or equal to a second threshold; or
a variation value between the first difference and the second difference is greater than or equal to a third threshold.

4. The communication method according to claim 1, wherein the first event is configured by using first information.

5. The communication method according to claim 4, wherein the first information is transmitted by using radio resource control (RRC) signalling.

6. The communication method according to claim 1, wherein the second network device is a satellite, and the communication method further comprises:
receiving, by the terminal, second information sent by the first network device,
wherein the second information comprises information about the satellite.

7. The communication method according to claim 6, wherein the information about the satellite comprises one or more of following information: ephemeris information of the satellite, an identity of the satellite, or an identity of ephemeris information of the satellite.

8. The communication method according to claim 6, wherein the second information is transmitted by using RRC signalling.

9. The communication method according to claim 1, wherein the delay difference is used by the first network device to determine measurement configuration information.

10. The communication method according to claim 9, wherein the measurement configuration information comprises synchronization signal block measurement timing configuration (SMTC) information and/or measurement gap configuration information.

11. The communication method according to claim 1, wherein
the first cell is a serving cell, and the second cell is a neighboring cell; or
the first cell is a neighboring cell, and the second cell is a serving cell.

12. A network device, the network device being a first network device, and comprising a processor and a memory, wherein the memory is configured to store a computer program, and the processor is configured to invoke and run the computer program stored in the memory to cause the first network device to perform:
receiving, in response to satisfaction of a first event, first indication information sent by a terminal,
wherein the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.

13. The network device according to claim 12, wherein
the first cell is a non-terrestrial network (NTN) cell; and/or
the second cell is an NTN cell.

14. The network device according to claim 12, wherein a first difference is a current delay difference, a second difference is a last reported delay difference, and the first event comprises that
a difference value between the first difference and the second difference is greater than or equal to a first threshold;
a difference value between the first difference and the second difference is less than or equal to a second threshold; or
a variation value between the first difference and the second difference is greater than or equal to a third threshold.

15. The network device according to claim 12, wherein the first event is configured by using first information.

16. The network device according to claim 15, wherein the first information is transmitted by using radio resource control (RRC) signalling.

17. The network device according to claim 12, wherein the second network device is a satellite, and the processor is further configured to invoke and run the computer program stored in the memory to cause the first network device to perform:
sending second information to the terminal,
wherein the second information comprises information about the satellite.

18. The network device according to claim 17, wherein the information about the satellite comprises one or more of following information: ephemeris information of the satellite, an identity of the satellite, or an identity of ephemeris information of the satellite.

19. The network device according to claim 17, wherein the second information is transmitted by using RRC signalling.

20. A terminal, comprising a processor and a memory, wherein the memory is configured to store a computer program, and the processor is configured to invoke and run the computer program stored in the memory to cause the terminal to perform:
sending first indication information to a first network device in response to satisfaction of a first event,
wherein the first indication information is used to indicate a delay difference, the delay difference is a difference between a first propagation delay and a second propagation delay, the first propagation delay is a propagation delay between the terminal and a second network device to which a first cell belongs, and the second propagation delay is a propagation delay between the terminal and a third network device to which a second cell belongs.
